(19) United States
(12) Patent Application Publication
(10) Pub. No.: US 2011/0132713 A1
(43) Pub. Date: Jun. 9, 2011

(54) SWITCHING ELEMENT COMPRISING AT LEAST ONE ELECTROACTIVE DIELECTRIC DEFORMATION MEMBER

(75) Inventors: Erwin Biegger, Wangen (DE); Thomas Rosemeier, Meckenbeuren (DE)

(73) Assignee: ZF FRIEDRICHSHAFEN AG, Friedrichshafen (DE)

(21) Appl. No.: 13/057,533

(22) PCT Filed: Aug. 10, 2009
(86) PCT No.: PCT/EP2009/060330

§ 371 Date: Feb. 4, 2011

(30) Foreign Application Priority Data
Aug. 20, 2008 (DE) 10 2008 041 403.4

(51) Int. Cl. F16D 13/22; F16D 28/00

(52) U.S. Cl. 192/66.1

(57) ABSTRACT

A shift element which, when actuated, can conduct at least first and second components (41, 42) into force-transmitting and releasable connection. The shift element comprises at least one deformation member (1) that can be actuated and which consists at least in part of a dielectric polymer by which the shift element can be actuated.

This application is a National Stage completion of PCT/EP2009/060330 filed Aug. 10, 2009, which claims priority from German patent application serial no. 10 2008 041 403.4 filed Aug. 20, 2008.

### FIELD OF THE INVENTION

The invention relates to a shift element by means of which when actuated, at least a first and second component can be brought into force-transmitting and releasable connection. The shift element operates as a brake or clutch preferably in a transmission, for example a vehicle transmission or a machine transmission.

### BACKGROUND OF THE INVENTION

From Japanese patent application JP 01-242830 A, a shift element is known, in this case a clutch for producing a releasable, force-transmitting connection between a first and a second component, which has a piezoelectric deformation member for its activation. For this, the deformation member is positioned against the first component in an intermediate space between the two components. To actuate the shift element the deformation member is acted upon electrically whereby it expands and comes into contact with the second component, so forming the force-transmitting connection between the first and second components.

From Japanese patent application JP 63-289333 A, a further shift element is known, again a clutch for forming a releasable force-transmitting connection between two components, which also has a piezoelectric deformation member for its actuation. The shift element also has two contact elements which are pressed against one another when the shift element is actuated, thereby forming the releasable connection between the two components.

From German patent application DE 102 13 915 A1 by the present applicant it is known to arrange a plurality of piezoelectric deformation members in a shift element, by means of which the shift element can be actuated.

Furthermore, from German patent application DE 10 2004 040 586 A1 by the present applicant it is known to actuate a shift element with an actuator made from an electro-strictive polymer.

Electrostrictive and piezoelectric deformation members have a very small control movement path, so in a shift element of the type mentioned, no reliable formation or separation of the connection between the components can be ensured without further means for increasing the movement path.

### SUMMARY OF THE INVENTION

The purpose of the present invention is therefore to provide a shift element of the type mentioned, which ensures reliable formation or separation of the connection between the components that can be releasably connected.

This objective is achieved by a shift element having the characterizing inventive features. According to this the deformation member for actuating the shift element consists at least in part of an electro-active dielectric polymer. In electro-active dielectric materials the deformation takes place by virtue of electrostatic forces, so compared with piezoelectric or electrostrictive materials they have considerably greater deformability. Accordingly, compared with a piezoelectric or electrostrictive deformation member a deformation member that consists at least in part of an electro-active dielectric material can produce substantially larger movement, which ensures reliable formation or separation of the force-transmitting connection between the components. In this case the electro-active dielectric material is a polymer, since compared with metallic or crystalline materials polymers have good damping behavior and are therefore less sensitive to mechanical vibrations such as those that occur in a transmission, which among other things results in longer life and better noise behavior.

In a first design feature of the invention the shift element comprises at least a first contact element in active connection with the first component and at least a second contact element in active connection with the second component. To actuate the shift element the first contact element can be moved by means of the deformation member between at least two positions, such that in the first position it is in force-transmitting contact with the second contact element whereby a force-transmitting connection is made by the deformation member between the first and second components, and in the second position the first contact element is moved away from the second contact element whereby the force-transmitting connection formed by the deformation member between the first and second components is separated.

In a second design feature of the invention the deformation member consists of at least one material layer rolled up on a longitudinal axis into a cylindrical shape. In this way a deformation that contracts the circumference of the deformation member at the same time brings about an expanding deformation along the longitudinal axis of the deformation member, which can be used effectively for actuating the shift element.

In a particularly preferred third design feature of the invention the deformation member is elastically prestressed, preferably by means of an elastic element such as a spring or a rubber-like component. In this way, at least in one movement direction the movement of the first contact element can either be assisted by the prestress, or even produced entirely by the prestress. Thus, the movement of the first contact element from the first position to the second position can for example be produced by the deformation member, and the return movement from the second position back to the first position can be produced by the prestress and the stress built up during the movement. Conversely, the movement can also be produced by the prestress and the return movement by the deformation member. Furthermore, action upon the deformation member by a prestress also stabilizes the dielectric polymer material of the deformation member and thus counteracts rapid aging of the deformation member.

In a fourth design feature of the invention the first contact element has a projection, for example a tooth or a claw, which comes into interlocked contact with the second contact element when the first contact element is in the first position. On the other hand the projection is released from the second contact element when the first contact element is in the second position.

In a fifth design feature of the invention the first contact element has at least one friction surface, which is in frictional or friction-force-producing contact with the second contact element, when the first contact element is in the first position. In this case, the surface moves clear of the second contact element when the first component is in the second position. Thus, the shift element can be an interlocking or a frictional brake or clutch, such that the contact elements can also be in contact with some slip between them so that, deliberately, only part of a force applied on one of the components can be transmitted to the other component.

In a preferred sixth design feature of the invention the shift element comprises a supporting component, such that the deformation member is supported on one side against the supporting component and the first contact element is moved between the first and second positions by the movable other side of the deformation member. In this way the deformation member can even be in direct contact against the supporting element and in direct contact against the first contact element. Likewise, however, other components can be arranged between the deformation member and the first contact element or between the deformation member and the supporting component, by which the deformation member is supported against the supporting component or by which the control movement of the deformation member is transmitted to the first contact element.

In a seventh design feature the deformation member is in contact on one side against the first contact element and with its other side against the supporting component, with the supporting component supported against the first component for force transmission and the second contact element against the second component for force transmission.

In general the first contact element or the supporting component can be supported against the first component for force transmission and the second contact element against the second component for force transmission in such manner that the contact elements or supporting component are arranged fixed in all directions relative to the component concerned. However, it can be expedient to arrange the first contact element or supporting component and/or the second contact element so that they can move on this first or second component transversely to the direction of the force transfer taking place between the first and second components, for example in that the second component has a surface profile suitable for this, running transversely to the force transmission direction, preferably a toothed profile, whereas the first or second contact element or the supporting component has one or more surfaces that slide along the profile. Thus, the support of the contact elements or the support of the supporting component for force transmission against the first or second component should be understood to happen in the sense that the contact elements or the supporting component are supported in a suitable manner against the first or second components, in order to enable the force-transmitting connection between these two components via the contact elements and support points. In this case the supporting can also be such that the second contact element or the supporting component is in fixed connection, for example by interlocked or material-integrated means, with the second component.

In eighth and ninth design features of the invention, the shift element comprises an axial bearing and the first contact element can rotate relative to the second contact element. In the eighth design feature of the invention the shift element is designed such that the first contact element can rotate relative to the deformation member and the axial bearing can be moved by the deformation member, so that by virtue of this displacement of the axial bearing the first contact element can be moved with rotation between the first and second positions. In contrast, in the ninth design feature of the invention the shift element is designed such that the deformation member together with the first contact element can rotate relative to the second contact element, in such manner that the deformation member is supported by the axial bearing so that it can rotate. In this case the deformation member can be supported both against the second component and also against a fixed supporting component such as, for example a housing.

In a tenth design feature of the invention the deformation member is supported with one side against the first component and rests on another side that can be moved by the deformation member against the first contact element. Here the first contact element is supported against the first component for force transmission and the second contact element is supported against the second component for force transmission. In this case the shift element preferably comprises a plurality of first and second contact elements and deformation members arranged one after another, preferably such that the first contact element rests against a second deformation member, which in turn rests against a further first contact element, which in turn rests against a third deformation member, which in turn rests against another first contact element. The first contact elements and the second and third deformation members are arranged and can move on the first component. Between each pair of first contact elements are in this case arranged one or more of the second contact elements, which are supported movably and for force transmission against the second component. When the deformation members are actuated, for example they contract, whereby the distance between the first contact elements decreases. During this the first and second contact elements come into force-transmitting contact, whereby the releasable force-transmitting connection between the first and the second component is formed.

In an advantageous configuration that uses a plurality of deformation members, each of which moves one of the first contact elements, the deformation members can be actuated individually or one after another, in particular for producing the force transmission in a sensitive manner. Likewise, the wear of the contact elements can be influenced selectively by actuating certain deformation members, for example a badly worn first contact element can be used less often for forming the force-transmitting connection between the first and second components than is a less badly worn first contact element.

In an eleventh design feature of the invention the shift element comprises a third contact element which cannot be moved by the deformation member and which is supported against the first or second component, at least for force transmission. In this case the first contact element can be moved by the deformation member in the direction of the third contact element, and one or more of the second contact elements are arranged and movable between the first and third contact elements. Here, the first contact element is moved by actuating the deformation member toward the third contact element, whereby the first and third contact elements come into contact with the second contact element(s), so forming the force-transmitting connection between the first and second component.

In a further development of the above the shift element has a fourth contact element, which is arranged and able to move between the first and third contact elements and is supported against the first component for force transmission. In this case one of the second contact elements is arranged, respectively, between the first contact element and the fourth contact element and between the third contact element and the fourth contact element.

When the deformation member is actuated the first contact element moves toward the third contact element, whereby the contact elements come into mutual contact and form the force-transmitting connection. The contact area available during this is additionally enlarged by the fourth contact element, whereby the control element can transmit larger forces and the thermal loading of the individual contact elements is reduced, which is particularly advantageous when the force-transmitting connection is formed by means of contact elements which rub against one another. It is also possible to provide more than one fourth contact element, and then one of the second contact elements is in each case between two of the fourth contact elements.

In a further design feature of the invention the shift element has at least two of the first contact elements, which are supported against the first component for force transmission and which, by means of a deformation member arranged between them, can be moved in a floating manner toward the first component. Likewise, one or more second contact elements are arranged and can move between the first contact elements and are supported for force transmission. In this case when the deformation member is actuated the first contact elements move in a floating manner toward one another, so that the first contact elements come into force-transmitting contact with the second contact elements. One or more further contact elements can here also be arranged movably between the first contact elements, which are supported against the first component for force transmission. In such a case, between each of the further contact elements and each of the first contact elements there is arranged a respective second contact element, and in each case a second contact element is also arranged between two of the further contact elements.

The first and/or the second component are preferably in the form of shafts and can rotate relative to one another, and the first or second component is hollow and at least partially surrounds at least the contact elements and the deformation members. When the shift element is a brake, the first component is preferably a housing within which the second component, in this case preferably a shaft, runs. When the shift element is a clutch, the first component is preferably an internal shaft which is surrounded by the second component, in this case preferably a hollow shaft.

Particularly when more than two of the contact elements are arranged in a shift element and are surrounded at least partially by a lubricant or coolant, it can happen that when the first contact element is located in the second position, i.e. when the force-transmitting connection between the first and second component is separated, some slight force transfer still takes place between the contact elements mainly due to shear stresses in the lubricant or coolant, and this is manifested in the form of so-termed drag losses. However, since the force transmitted thereby is very small compared with the force that can be transmitted by the shift element in its engaged condition, the force-transmitting connection between the first and second components when a shift element according to the invention is disengaged, can be regarded as separated despite any drag losses that may be occurring.

### BRIEF DESCRIPTION OF THE DRAWINGS

Below, the invention is explained in more detail with reference to examples and drawings from which further advantageous design features emerge. The drawings show, in each case represented schematically:

FIG. 1: A shift element with a plurality of first and second contact elements, a plurality of supporting components, and with a plurality of deformation members, and with a first component in the form of a hollow shaft against which the supporting components are supported for force transmission, and with a second component in the form of an inner shaft, against which the second contact elements are supported for force transmission;

FIG. 2: A shift element with a plurality of first contact elements and deformation members arranged one after another and elastically prestressed, and with a third contact element, as well as a first component in the form of a hollow shaft and a second component in the form of an inner shaft;

FIG. 3: A further development of the shift element in FIG. 2, with two fourth contact elements, which are arranged between the first contact elements and between a first and a third contact element;

FIG. 4: A section through the shift element in FIG. 3 along the plane marked A-A in FIG. 3, in which the guides for the fourth contact elements arranged on the first contact elements and on the third contact element can be seen;

FIG. 5: Another shift element with a first and a third contact element and with a plurality of second and fourth contact elements arranged between the first and the third contact element

FIG. 6: A section showing a further development of the shift element in FIG. 5, in which the area marked B in FIG. 5, has been modified;

FIG. 7: A shift element with a fixed supporting component and with a movable axial bearing, such that the deformation member is supported against the supporting component and the first contact element can be moved by virtue of the axial bearing; and

FIG. 8: A shift element with two first contact elements and with a plurality of second and further contact elements arranged between the first contact elements.

### DETAILED DESCRIPTION OF THE PREFERRED EMBODIMENTS

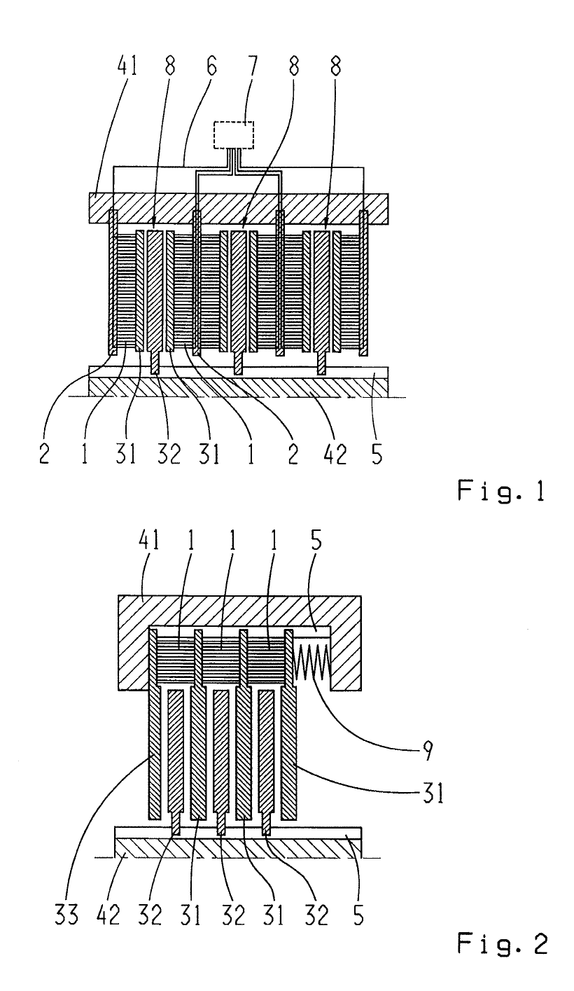

FIG. 1 shows the sectioned half of a shift element with six deformation members 1 that can be actuated, each connected on one side to a supporting component 2 and on another side to a first contact element 31. Each supporting component 2 is arranged fixed on a first component 41 and supported against it for force transmission. Between the first contact elements 31, three second contact elements 32 are arranged and able to move on a second component 42, and are supported thereon for force transmission, for which purpose the second component 42 has at least one-groove-shaped recess 5 extending transversely to the force transmission direction, in which the second contact elements 32 engage. In FIG. 1 the first contact elements 31 are in their second position, detached from the second contact elements 32. The first component 41 is in the form of a hollow shaft and the second component 42 is a shaft, the two components 41, 42 being coaxial with one another and able to rotate relative to one another. Thus, the first and second contact elements 31, 32 can also rotate relative to one another. Here, the first component 41 can be regarded as an outer disc carrier of a disk brake or disk clutch, such that the supporting components 2 form outer disks and the second component 42 can be regarded as an inner disk carrier such that the second contact elements 32 form inner disks. The deformation member 1 consists of several layers of an electro-active dielectric polymer material, which can be actuated electrically via control lines 6. The layers extend transversely to the deformation used for moving the first contact element 31. The effect of this deformation caused by actuating the deformation member 1 is that in each case one of the first contact elements 31 is moved toward one of the second contact elements 32. Alternatively the deformation member 1 can also consist of at least one layer rolled to form a cylinder, such that the longitudinal direction around which the layer is rolled extends in the movement direction of the first contact element 31. The control lines 6 are preferably connected to a control unit 7, for example an electronic control unit of a vehicle transmission, which actuates the deformation members 1 individually or conjointly. However, the control lines 6 can also lead to a switch or regulator which enables an operator to control manually the deformation of the deformation members 1 and hence the formation or separation of the force-transmitting connection between the first and second components 41, 42.

To produce the force-transmitting connection, at least two deformation members 1 opposite each other are subjected to an electric voltage via the control lines 6, whereby under the action of the electric field build-up the deformation members 1 deform by expanding toward the first contact elements 31. Since the deformation members 1 are supported each with a side against the fixed supporting component 12, when the deformation members 1 opposite one another are actuated the first contact elements 31 move toward one another, out of the second position shown and into the first position. During this the second contact element 32 positioned between the first contact elements 31 comes into contact with the first contact elements 31, so forming the force-transmitting connection between the first and second components 41, 42.

The shift element shown in FIG. 1 comprises three such pairs 8 of opposed and conjointly moved contact elements 31, so that the shift element can be actuated in at least three steps. Since by means of each of these pairs 8 preferably only a limited force can be transmitted from the first to the second component 41, 42 and if that force is exceeded the contact elements 31, 32 slide over one another with friction, the shift element can also be used similarly to a slipping clutch as a shiftable force-limiter. Thus, for limited transmission of a small force only one pair 8 of opposed first contact elements 31 can be actuated, to transmit a limited force of medium strength two pairs 8 can be actuated, and to transmit a maximum force all the pairs 8, i.e. all the deformation members 1 can be actuated.

For a more finely graded actuation of the shift element, the second contact elements 32 can also be connected fixed to the second component 42, whereby on one-sided contact with one of the first contact elements 31, the second contact elements 32 cannot cause it to give way by a sliding movement. Thus, the deformation members 1 can be actuated individually in order to bring the first contact elements 31 individually into contact with the second contact elements 32 for producing the force transmission between the first and second components 41, 42.

The contact elements 31, 32 and supporting components 2 shown in FIG. 1 are one-piece disks arranged around the first component 41. In this case the deformation members 1 can each form a continuous or segmented disk arranged concentrically around the first component 41, each of which moves one of the first contact elements 31, or else a plurality of deformation members 1 can be arranged on each supporting component 2, each moving one of the first contact elements 31. Not illustrated in this case is that the deformation members 1 are preferably each prestressed by elastic elements, for which purpose in particular preferably one or more elastic elements are arranged, with prestress, between respective pairs of opposite first contact elements 31.

FIG. 2 shows a section through half of a control element with a plurality of first contact elements 31 and deformation members 1 arranged in a row one after another, such that the first contact elements 31 are elastically prestressed against the deformation members 1 by an elastic element 9, in this case shown for example as a spiral compression spring. As in FIG. 1 the first and second components 41, 42 can rotate relative to one another, the first component 41 being in the form of a hollow shaft which surrounds the second component 42, the contact elements 31, 32, 33 and the deformation member 1. The second component 42 is arranged coaxially to the first component 41 and the deformation members 1 are supported indirectly or directly against the first component 41. Since the third contact element 33 serves as a stop for the contact elements 31, 32, it is supported against the first component 41 and cannot be moved by the deformation members 1. For force transmission between the contact elements 31, 32, 33 and the first and second components 41, 42 the two components 41, 42 each have at least one groove-shaped recess 5 extending transversely to the force transmission direction, in which the contact elements 31, 32, 33 engage and can be displaced along the recess 5. Instead of a recess 5 the components 41, 42 can also for example have a polygonal or serrated cross-section against which the contact elements 31, 32, 33 are in shape-enclosing contact and can move in the longitudinal direction.

To actuate the control element the deformation members 1 are actuated, whereby they move the first contact elements 31 by contracting. During this, one of the second contact elements 32 comes into force-transmitting contact with one of the first contact elements 31 and the third contact element 33, and the other second contact elements 32 come into respective force-transmitting contact with two of the first contact elements 31, whereby the force-transmitting connection between the first component and the second component 41, 42 is formed. The elastic element 9, which among other possibilities can even be of rubbery type, holds the deformation members 1 and the first contact elements 31 under prestress so that they rest firmly in mutual contact and do not have to be joined, for example by bonding.

In an alternative design of the shift element in FIG. 2, in the initial position, i.e. when the deformation members 1 are not actuated, the contact elements 31, 32, 33 are in mutual force-transmitting contact, whereby the force-transmitting connection between the first and second components 41, 42 exists. When the deformation members 1 are actuated the first contact elements 31 are moved by an expansion against the stress of the elastic element 9, so that the contact elements 31, 32, 33 move apart and the force-transmitting connection between the two components 41, 42 is separated. To form the force-transmitting connection between the first and second components 41, 42 the actuation of the deformation members 1 is suppressed, for example by cutting off an actuating voltage, as a result of which the deformation members 1 resume their original shape and the elastic element 9 presses the contact elements 31, 32, 33 against one another. Thus, in this design the deformation members 1 shown in FIG. 2 are in an actuated, expanded condition. Such a shift element, which applies the control force required for forming the force-transmitting connection between the components 41, 42 by means of the elastic element 9 instead of by the deformation members 1, is particularly suitable for safety-relevant applications, for example emergency brakes, since the separation of the force transmission is only maintained while the deformation of the deformation members 1, which requires energy input, persists. As soon as the energy supply to the deformation members 1 is cut off, for example if there is an electric system failure, the force-transmitting connection between the components 41, 42 is formed, and this engages the emergency brake mentioned as an example. Thus, such a shift element is suitable for a holding or parking brake of a motor vehicle, in particular a hybrid vehicle with an electric motor and an internal combustion engine which, in the event that the vehicle's battery has run down, remains secured against rolling away by the shift element.

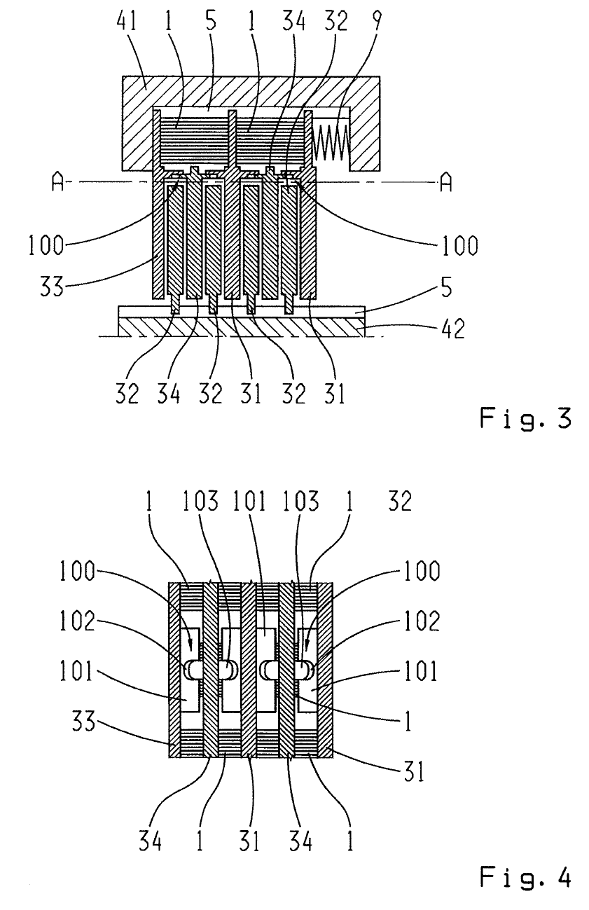

FIG. 3 shows a further development of the shift element of FIG. 2, in which fourth contact elements 34 are arranged in each case between the third contact element 33 and one of the first contact elements 31 and between two of the first contact elements 31. These fourth contact elements 34 can be displaced by virtue of guiding means 100 of the third contact element 33 and the first contact elements 31, and are supported indirectly against the first component 41 for force transmission. Here, the fourth contact elements 34 increase the contact area used for forming the force-transmitting connection between the first and second components 41, 42, while maintaining the number of deformation members 1 the same. A shift element fitted with the fourth contact elements 34 can therefore, with the same type and number of deformation members 1, transmit larger forces between the first component 41 and the second component 42 than can a shift element without fourth contact elements 34. To form the force-transmitting connection between the first and second components 41, 42, the deformation members 1 are actuated, so that they contract and bring the contact elements 31, 32, 33, 34 into force-transmitting contact with one another.

The grinding means 100 of the first and third contact elements 31, 33 for the fourth contact elements 34 can be seen in FIG. 4, which shows a section through the shift element along the plane marked A-A in FIG. 3. In this case the guiding means 100 consist of plate-shaped projections 101 arranged on the first and third contact elements 31, 33, in which stepped recesses 102 extending transversely to the force transmission direction are formed. In addition the guiding means 100 comprise further, stud-shaped projections 103 arranged on the fourth contact elements 34, which project into the recesses 102 and can slide within them, and which contact the sides of the recesses 102 for force transmission.

From FIG. 4 it can also be seen that a first contact element 31 does not necessarily have to be moved by a single deformation member 1, but rather, each first contact element 31 can also be moved by more than one deformation member 1, which can have almost any desired shape.

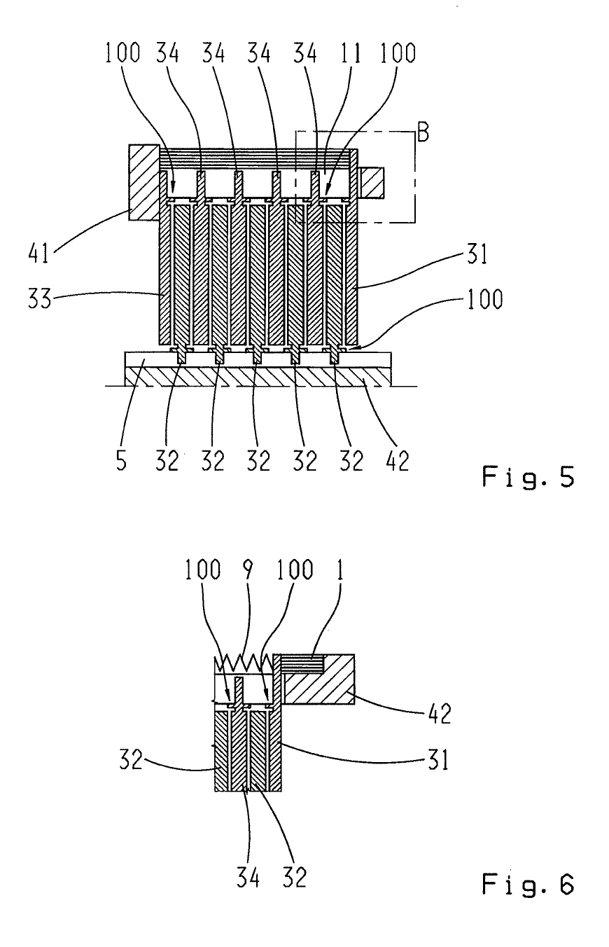

FIG. 5 shows a section through half of a shift element with a plurality of contact elements 31, 32, 33, 34 arranged in line one after another. The first component 41 and the second component 42 can rotate relative to one another and are arranged coaxially. By contraction, the deformation member 1 moves the first contact element 31 toward the third contact element 33, whereby the contact elements 31, 32, 33, 34 come into force-transmitting connection between the first and second components 41, 42. In this case an opening 11 is formed in the first component 41, by virtue of which the first contact element 31 and the fourth contact element 34 arranged between the first and third contact elements 31, 33 can be moved and guided, and by virtue of which the first and third contact elements 31, 33 and the fourth contact elements 34 are supported against the first component 41 for force transmission. On the second component 42 the second contact elements 32 can move and are supported in a recess 5 for force transmission. In this case the contact elements 31, 32, 33, 34 also comprise guiding means 100 by means of which they are fixed on the first and second components 41, 42 in the radial direction. To prestress the deformation member 1, an elastic element (not shown) is preferably arranged between the first component and the first contact element.

FIG. 6 shows a section of a further development of the control element in FIG. 5, with modifications in the area of FIG. 5 marked B. Compared with the control element in FIG. 5, in the control element of FIG. 6 the arrangement and shape of the contact elements 31, 32, 33, 34 is the same, but to form the force-transmitting connection between the first and second components 41, 42 an expansion of the deformation member 1 is used, instead of a contraction. Furthermore an elastic element 9 is arranged between the first component 41 and the first contact element 31, which acts with a stress against the deformation member 1. If the energy supply to the deformation member 1 fails, this ensures that the first and third contact elements 31, 33 are pushed apart and the force-transmitting connection between the first and second components 41, 42 is broken.

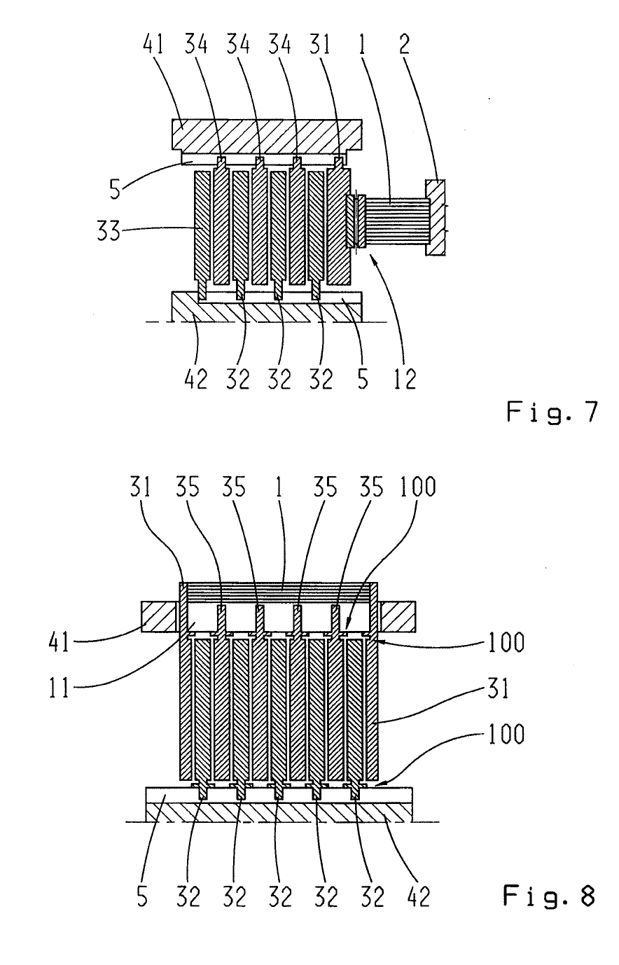

The shift element shown in FIG. 7 can be used to produce a force-transmitting connection between two components 41, 42 arranged coaxially and able to rotate relative to one another. In this case the deformation member 1 is supported fixed with one side against a supporting component 2 and contacts the movable axial bearing 12 on another side. The first contact element 31 is in contact with another side of the axial bearing 12 that can rotate, so that an expanding deformation of the deformation member brings about a displacement of the axial bearing 12 which in turn causes the first contact element 31 to move from the first position shown to the second position, in which the contact elements 31, 32, 33 are in force-transmitting contact. To secure the first contact element 31 on the axial bearing 12 and to produce the return movement of the first contact element 31 from the second to the first position, the first contact element 31 is preferably prestressed by an elastic element (not shown) against the axial bearing 12 and thus against the deformation member 1. On the second component 42 there is a third contact element 33 which cannot be moved by the deformation member 1 and which, for force transmission, is supported against the second component 42. In addition, on the second component 42 three second contact elements 32 are arranged, all can move between the first and third contact elements 31, 33, which are supported for force transmission, and on the first component 41 three fourth contact elements 34 are arranged and can move, which are supported for force transmission. When the first contact element 31 moves from the first to the second position, the contact elements are pressed against one another between the first and third contact elements 31, 33 in a force-transmitting manner so that the force-transmitting connection between the first and second components 41, 42 is produced. For guiding the contact elements 31, 32, 33, 34 on the first and second components 41, 42, each of the two components 41, 42 has at least one recess 5 in which the respective contact elements 31, 32, 33, 34 engage.

Alternatively, the axial bearing 12 can be arranged between the deformation member 1 and the supporting component 2 and can be unable to move, whereby the deformation member 1 together with the first contact element 31 can then rotate relative to the second component 42 and the supporting component 2 and is supported against the supporting component 2 by the axial bearing 12.

In the embodiment shown in FIG. 7 the shift element preferably serves as a clutch between the first and second components 41, 42. In this case the deformation member 1 is preferably actuated via control lines (not shown) which are arranged in or on the supporting component 2. However, the supporting component 2 can also be connected fixed to the second component 2.

In the shift element shown in cross-section in FIG. 8, the first and second components 41, 42 are coaxial and can rotate relative to one another. In this case the first component 41 has an opening 11 in which two first contact elements 31 are supported and able to move in a floating manner, against the first component 41 for force transmission. Between the two first contact elements 31 is arranged a deformation member 1 by which the first contact elements 31 can be moved. In addition, between the first contact elements 31 there are a plurality of second contact elements 32, which can move on the second component 42 by virtue of the recess 5 and are supported for force transmission, and between the first contact elements 31 there are also further contact elements 35 which can move on the first component 41 and are supported for force transmission. When the deformation member 1 is actuated it contracts and the first contact elements 31 move toward one another, whereby the contact elements 31, 32, 35 come into force-transmitting contact and so form the force-transmitting connection between the first and second components 41, 42. Correspondingly to the contact elements 31, 32, 33, 34 in FIG. 5, the contact elements 31, 32, 35 in FIG. 8 have guiding means 100 by virtue of which the contact elements 31, 32, 35 are fixed in the radial direction against the first or second components 41, 42.

In this case, to prestress the deformation member 1 an elastic element acting under tension can be arranged between the first contact elements 31, for example a tension spring, or a bracket-shaped elastic element can act from outside on the first contact elements 31 and thereby prestress the deformation member 1.

In the control elements shown in FIGS. 1 to 8, the first component 41 is in each case a hollow shaft which surrounds the second component 42 made as an inner shaft. Needless to say, however, it is also possible for the second component 42 to be a hollow shaft which then surrounds the first component 41 made as an inner shaft.

Instead of between rotating components 41, 42, a shift element designed in accordance with the invention can also transmit force between components that can be displaced relative to one another, and then contact elements are arranged next to one another along the displacement direction of the components. For example, the first and second components 41, 42 in FIG. 1 can be plate-shaped and movable relative to one another perpendicularly to the plane of the drawing, whereas the first and second contact elements 31, 32 are arranged as shown and are supported against the first or the second component 41, 42.

In general the contact elements 31, 32, 33 34, 35 and the supporting components 2 can consist of a plurality of components connected to one another. For example, to improve the force transmission the contact elements 31, 32, 33, 34, 35 can have friction linings on which they come in contact with the other contact elements 31, 32, 33, 34, 35 when the deformation member or deformation members is/are actuated. The contact elements 31, 32, 33, 34, 35 can therefore consist of two parts connected by a damper or by an elastic element, in order to attenuate any force impulses in the first and second components 41, 42 during the formation of the force-transmitting connection between them.

As described, the contact elements 31, 32, 33, 34, 35 are designed such that force is transmitted between them either by virtue of friction or frictional action, or due to positive interlock. It is also possible for one or more contact elements 31, 32, 33, 34, 35 in the shift element to form the force-transmitting connection of the components 41, 42 by friction and one or more contact elements 31, 32, 33, 34, 35 to form the force-transmitting connection of the components 41, 42 by virtue of interlock. In this way the contact elements 31, 32, 33, 34, 35 that act by friction can be brought into contact first by means of one or more deformation member(s) 1 in order to form a first force-transmitting connection between the first and second components 41, 42, for example in order to synchronize speed differences between the two components 41, 42. Thereafter, the contact elements 31, 32, 33, 34, 35 that act by interlock can be brought into contact by means of one or more other deformation member(s) 1 in order to complete the force-transmitting connection between the components 41, 42. For an interlocking contact between the contact elements 31, 32, 33, 34, 35 they each have at least one projection which, when the deformation member(s) 1 is/are actuated, interacts by positive interlock with one another. The projections are preferably teeth or claws.

Particularly when friction is used to produce the force transmission, the size of the force that can be transmitted from the first to the second component 41, 42 depends on the one hand directly on the control force with which two contact elements 31, 32, 33, 34, 35 in contact with one another are pressed together. On the other hand the size of the force that can be transmitted depends on the contact area over which the two contact elements 31, 32, 33, 34, 35 are in mutual contact. To increase the contact area, in the case of components 41, 42 that rotate relative to one another the contact elements 31, 32, 33, 34, 35 are preferably of conical shape. To increase the control force, a force converter is preferably arranged between the deformation member 1 and the first contact element 31, which increases the force produced by the deformation member 1 by shortening the control path produced. A force converter of such type can be a known mechanical lever or a known diaphragm, with a long end on which the deformation member 1 acts with a small force over a large control path and a short end, which can deliver a large control force over a short control path. Another converter is of known hydraulic type, with a piston of small diameter on which the deformation member 1 acts with a small force over a long control path and a piston of large diameter that can deliver a large control force over a short control path. Such converters can of course be used in the converse manner in order to increase the control path produced by the deformation member 1 while reducing the control force.

In general, the deformation member 1 is preferably such that on actuation it can be deformed continuously and/or the control force produced by the deformation member 1 when actuated can be adjusted continuously up to a maximum force. For example, the control path and the force produced can be proportional to an electric voltage applied to the deformation member 1. In this way the force transmitted by the control element from the first component 41 to the second component 42 can be limited in a continuous manner, such that above the force, limit slipping of the contact elements 31, 32, 33, 34, 35 takes place.

### Indexes

1 Deformation member
2 Supporting component
5 Recess
6 Control line
8 Pair of first contact elements
9 Elastic element
11 Opening
12 Axial bearing
31 First contact element
32 Second contact element
33 Third contact element
34 Fourth contact element
35 Further contact element
41 First component
42 Second component
100 Guiding means
101 Projection
102 Recess
103 Projection

1-18. (canceled)

19. A shift element by which, when the shift element is actuated, at least first and second components (41, 42) are brought into one of a force-transmitting and a releasable connection,
the shift element having at least one deformation member (1) that is actuatable, by which the shift element is actuated, and
the deformation member (1) comprising an electro-active dielectric polymer.

20. The shift element according to claim 19, wherein the shift element comprises at least one first contact element (31) which is actively connected to the first component (41), and at least one second contact element (32) which is actively connected to the second component (42) so that, to actuate the shift element, the first contact element (31) is moved by the deformation member (1) between at least first and second positions and, in the first position, the first contact element (31) is in force-transmitting contact against the second contact element (32) such that a force-transmitting connection brought about by the deformation member (1) is formed between the first and the second components (41, 42) and, in the second position, the first contact element (31) is released from the second contact element (32) such that the force-transmitting connection brought about by the deformation member (1) between the first and the second components (41, 42) is separated.

21. The shift element according to claim 19, wherein the deformation member (1) comprises at least one layer which is rolled up about a longitudinal axis to form a cylinder.

22. The shift element according to claim 19, wherein the deformation member (1) is elastically prestressed.

23. The shift element according to claim 20, wherein at least the first contact element (31) has at least one projection which, when the first contact element (31) is located in the first position, is in interlocked contact with the second contact element (32).

24. The shift element according to claim 20, wherein at least the first contact element (31) has at least one friction surface which, when the first contact element (31) is located in the first position, is in one of a frictional and a friction-force contact with the second contact element (32).

25. The shift element according to claim 20, wherein the shift element comprises at least one supporting component (2), and the deformation member (1) has one side which is supported against the supporting component (2) and has another side which is movable by deformation of the deformation member (1) and by which the first contact element (31) is moved between the first and the second positions.

26. The shift element according to claim 25, wherein the deformation member (1) rests with one side against the supporting component (2) and with another side against the first contact element (31), such that the supporting component (2) is supported against the first component (41) for at least force transmission and the second contact element (32) is supported against the second component (42) for force transmission.

27. The shift element according to claim 20, wherein the shift element comprises an axial bearing (12) that is moved by the deformation member (1) and the first and the second contact elements (31, 32) rotate relative to one another such that the first contact element (31) is moved by displacement of the axial bearing (12), between the first and the second positions, and is rotatable in relation to the deformation member (1).

28. The shift element according to claim 20, wherein the shift element comprises an axial bearing (12) and the first and the second contact elements (31, 32) rotate relative to one another such that the deformation member (1), together with the first contact element (31), rotate relative to the second contact element (32), and the deformation member (1) is supported and rotates by virtue of the axial bearing (12).

29. The shift element according to claim 20, wherein the deformation member (1) is supported, on one side, by the first component (41) and is in contact, with another side, against the first contact element (31), the first contact element (31) is supported against the first component (41) for force transmission and the second contact element (32) is supported against the second component (42) for force transmission.

30. The shift element according to claim 29, wherein the shift element comprises at least one third contact element (33) supported against one of the first component (41) and against the second component (42) for at least force transmission, the at least one third contact element (33) is immovable by the deformation member (1) such that the first contact element (31) is moved toward the third contact element (33) by the deformation member and such that at least one of the second contact elements (32) are arranged and movable between the first and the third contact elements (31, 33).

31. The shift element according to claim 30, wherein the shift element comprises at least two second contact elements (32) and a fourth contact element (34), which is arranged and movable between the first and the third contact elements (31, 33) and is supported for force transmission against the first component (41), and one of the at least two second contact elements (32) is arranged between the third and the fourth contact elements (33, 34) and another one of the at least two second contact elements (32) is arranged between the first and the fourth contact elements (31, 34).

32. The shift element according to claim 31, wherein the shift element comprises a plurality of the second and the fourth contact elements (32, 34), with one of the second contact elements (32) arranged between each pair of the fourth contact elements (34).

33. The shift element according to claim 29, wherein the first contact element (31) rests against a second deformation member (1) which, in turn, rests against a further first contact element (31) which, in turn, rests against a third deformation member (1) which, in turn, rests against another first contact element (31), such that at least one of the second contact elements (32) is arranged between each pair of the first contact elements (31), the second contact elements (32) is supported and movable on the second component (42).

34. The shift element according to claim 20, wherein the shift element comprises at least two of the first contact elements (31), which are supported for force transmission against the first component (41), and the at least two first contact elements (31) are moved by a respective deformation member (1) arranged between them, at least one of the second contact elements (32) is arranged and movable between the at least two first contact elements (31) and supported for force transmission against the second component (42).

35. The shift element according to claim 34, wherein the shift element comprises at least one further contact element (35) which is arranged and movable between the at least two first contact elements (31) and is supported for force transmission against one the at least two first component (31), respectively with one of the second contact elements (32) arranged between one of the at least two first contact elements (31) and the further contact element (35).

36. The shift element according to claim 35, wherein the shift element comprises a plurality of the second and a plurality of the further contact elements (32, 35), and one of the second contact elements (32) arranged between each pair of the further contact elements (35).

37. A shift element comprising at least first and second components (41, 42) and a deformation member (1) that comprises an electro-active dielectric polymer, the deformation member (1) engaging at least one first contact element (31) being rotationally fixed to and axially slidable along the first component (41), at least one second contact element (32) being rotationally fixed to and axially slidable along the the second component (42),
the deformation member (1) being actuatable to axially bias the at least one first contact element (31) along the first component (41) between first and second axial positions;
in the first axial position, the at least one first contact element (31) engages the second contact element (32) such that force is transmitted between the first and the second components (41, 42); and
in the second axial position, the at least one first contact element (31) disengages the second contact element (32) such that transmission of the force between the first and the second components (41, 42) is prevented.
